(19) United States
(12) Patent Application Publication
(10) Pub. No.: US 2017/0255775 A1
(43) Pub. Date: Sep. 7, 2017

(54) SOFTWARE VERIFICATION SYSTEMS WITH MULTIPLE VERIFICATION PATHS

(71) Applicant: Apple Inc, Cupertino, CA (US)

(72) Inventor: Damien P. Sorresso, San Francisco, CA (US)

(21) Appl. No.: 15/266,363

(22) Filed: Sep. 15, 2016

Related U.S. Application Data
(60) Provisional application No. 62/302,589, filed on Mar. 2, 2016.

(51) Int. Cl. G06F 21/56; G06F 21/57

(52) U.S. Cl. CPC G06F 21/563; G06F 21/575; G06F 2221/033; G06F 3/04817

(57) ABSTRACT

Systems, methods, and machine readable media are described which use code verification to verify the authenticity of installed software. The code verification can be performed in any one of a set of different paths, in one embodiment, which includes a first path using a trust cache of hashes of operating system components and one or more platform applications that are included together in a static software build that is installed on a system and a second path which evaluates code figured with one or more certificates (e.g. code signatures) for a software component (e.g. a third party software application or daemon) that is not part of the static software build. The path taken by a code verification process is audited to verify that the system has not been compromised.

This application claims the benefit of U.S. Provisional Patent Application No. 62/302,589, filed on Mar. 2, 2016, which application is incorporated herein by reference.

### BACKGROUND OF THE INVENTION

The present disclosure relates to security for information technology and more particularly relates to methods, systems and computer readable media for protecting data processing systems from malware or other security problems created by software.

Many existing data processing systems use techniques to prevent malware or other software from affecting the operation of the system. One such technique involves booting a system (such as a computer, smartphone or tablet computer) via a secure boot ROM which is the start of a chain of trust that proceeds through the use of a series of code signatures up the chain of trust. The iOS operating system from Apple Inc. provides such a technique for securely booting an iPhone or iPad. Another technique which can be used in the prior art is to sign executable code provided from a third party application developer with a certificate issued by an operator of an application store. This signed code can be verified to be authentic at run time, and thereby prevent malware, which would not be verified to be authentic, from running. Apps available from the Apple app store for iOS are examples of applications that are signed before being made available on an application store.

### SUMMARY OF THE DESCRIPTION

Systems, methods, and machine readable media are described which use code verification to verify the authenticity of installed software. The code verification, in one embodiment, can be performed using a set of different paths which includes a first path that uses a trust cache of hashes of operating system components and platform applications that are included together in a software build that is installed on a system and a second path which evaluates code signed with one or more certificates (for example, code signatures) for a software component, such as software from a third party software application or daemon that is not part of the software build. The path taken by the code verification process is audited to verify that the system has not been compromised by malware or other malicious software.

In one embodiment, a method for performing this code verification can include: determining an expected path of a code verification process for a first software component, wherein the code verification process has at least two paths which are different and wherein the first software component is a software application or a software daemon; causing the code verification process to perform a code verification on the first software component to determine whether the first software component is authentic; comparing the expected path to the path taken by the code verification process when the code verification on the first software component was performed: causing a protective action to occur in response to determining from the comparison that the path taken does not match the expected path. In one embodiment, the code verification process can record the path taken, and the two paths can include a first path for checking a trust cache of hashes of binaries from a build of an operating system and platform applications (and platform daemons) and a second path for evaluating a signature of signed code for a software component. In one embodiment, the expected path is determined by a first daemon which launches software components including software applications and software daemons. In one embodiment, the first daemon is the first user process which is launched in user memory space after a set of one or more kernel software components establish a kernel memory space during a secure boot up procedure which verifies code signatures in a chain of trust starting from a secure boot ROM.

In one embodiment, the first daemon determines the expected path based upon the source of the request or job to launch the first software component; the source, in one embodiment, can be either (1) a property list (or similar data structure) used by the first daemon to launch “system” or platform daemons (e.g. platform daemons bundled with the operating system), where the property list can specify a list of platform daemons and their storage locations (e.g. pathnames in a file system) in a persistent storage such as flash memory or (2) a user application that presents a user interface which shows icons or other selectable items that allow a user to select an application to cause the application to be launched or to run. In this embodiment, if the source is a property list then the expected path is the first path; the property list in this case includes a list of platform daemons that are expected to be bundled with a software build of the operating system, and therefore the software verification process is expected to use the trust cache. If the source is the user application that is used by a user to select an application (to cause it to be launched) then the expected path is the second path (which evaluates a signature of signed code) unless the user application indicates that the user's selected application is a platform application in which case the expected path is the first path. In one embodiment, the user application displays icons of both platform applications and third party applications, and the user application specifies to the first daemon whether the user's selected application is a platform application or a third party application.

In another embodiment, the first daemon determines the expected path from a property list used by the first daemon, and the property list specifies a storage location (e.g. pathname) that determines either the first path for the first software component or the second path for the first software component. In one embodiment, the first daemon causes the launching of a set of software daemons which is specified in the property list, and the property list also specifies a set of addresses or paths used to launch each software daemon in the set of software daemons.

In one embodiment, the first daemon, after it is launched, launches a software application that presents a graphical user interface which shows icons on a touch sensitive screen that allows the user to select an icon to launch the application represented by that icon.

In one embodiment, the protective action is one of: rebooting the data processing system to a restore mode requiring a re-installation of software; rebooting the data processing system to a recovery mode; causing a kernel panic; or disabling the first software component.

The methods described herein can be implemented by data processing systems, such as a smartphone or desktop computer or laptop computer or tablet computer or other consumer electronic devices. The methods described herein can also be implemented by one or more data processing systems which execute executable instructions, stored on one or more non-transitory machine readable media, that cause the one or more data processing systems to perform one or more of the methods described herein. Thus, the embodiments described herein include methods, data processing systems, and non-transitory machine readable media.

The above summary does not include an exhaustive list of all embodiments in this disclosure. All systems and methods can be practiced from all suitable combinations of the various aspects and embodiments summarized above, and also those disclosed in the Detailed Description below.

### BRIEF DESCRIPTION OF THE DRAWINGS

The present invention is illustrated by way of example and not limitation in the figures of the accompanying drawings in which like references indicate similar elements.

FIG. 1 shows an example of software and data stored on one or more machine readable media according to one embodiment.

FIG. 2 shows an example of a property list which can be used by a launcher software component according to one embodiment.

FIG. 3 is a flowchart which illustrates a method which can be used with one or more embodiments described herein.

FIG. 4 is a flowchart which shows a method which can be used with one or more embodiments described herein.

FIG. 5 is a flowchart which shows a method which can be used with one or more embodiments described herein.

FIG. 6 is a block diagram of an example of a data processing system that can be used to implement or perform one or more embodiments described herein.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

The embodiments described herein can be used to enhance the security of a data processing system, such as a smartphone or laptop computer. For example, the embodiments described herein can be used to stop jailbreaks of a device (such as a smartphone) from persisting across reboots when a hacker or jail breaker has laid down a file at a memory address they know will be executed. The one or more embodiments herein can be used to audit the path taken by code verification software, and when the path taken does not match an expected path determined by the system for a given software component, then the system can take protective action.

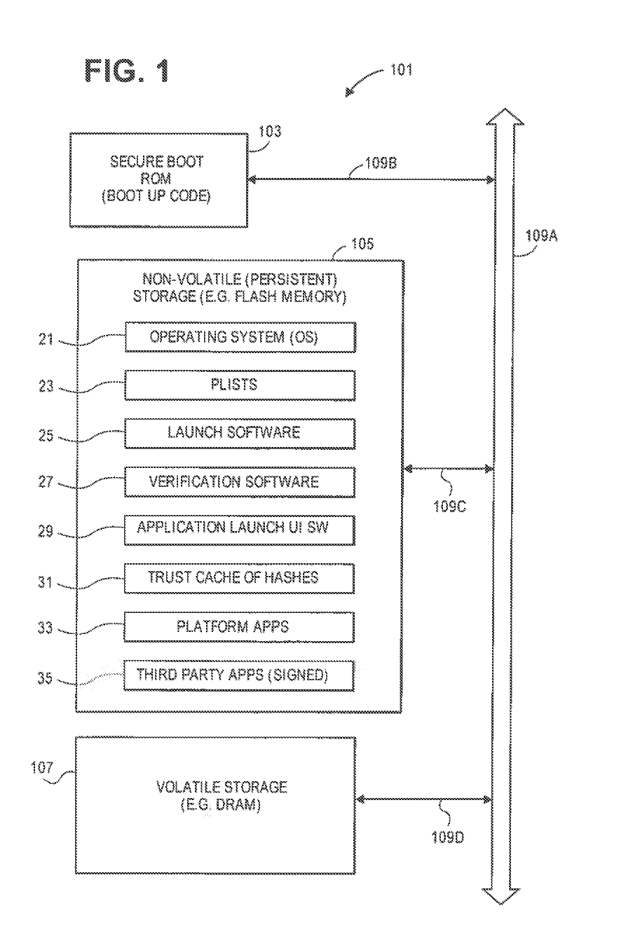

FIG. 1 shows an example of a software and data architecture according to one embodiment which can audit a path taken by code verification software, such as the verification software 27 shown in FIG. 1. The system 101 shown in FIG. 1 includes a secure boot ROM 103, a non-volatile (persistent) storage 105 (such as flash memory), volatile storage 107 (such as DRAM), one or more system buses 109A and several interconnects 109B, 109C and 109D. The storage 105 can contain images of the various software components and data files, and these images are used at run time to create executing code which are stored in the volatile storage 107 which in one embodiment can be dynamic random access memory (DRAM). The secure boot ROM 103 and the non-volatile storage 105 and the volatile storage 107 can be coupled through one or more interconnects to one or more system buses, such as system bus 109A. In the example shown in FIG. 1, the secure boot ROM 103 is coupled via interconnect 109B to the system bus 109A while the flash memory or other non-volatile storage 105 is coupled by interconnect 109C to one or more system buses 109A. Similarly, volatile storage 107 is coupled by interconnect 109D to one or more system buses 109A as shown in FIG. 1. The system 101 also normally includes one or more processes and input/output devices.

The secure boot ROM 103 can contain boot up code that in one embodiment can implement a boot up process from boot code stored in the read only memory which is implicitly trusted. The boot ROM code can contain a root certificate authority public key, such as a root certificate authority public key which is used to verify that the boot up code is signed by a trusted entity, such as the vendor of the device or operating system, before allowing it to load. This is the first step in the chain of trust where each step ensures that the next is signed by the vendor of the system, such as Apple in one embodiment. When the boot code finishes its loading process, it verifies and runs the next stage loader which in turn can verify and load the kernel of the operating system, such as operating system 21, which can be stored in non-volatile (persistent) storage, such as flash memory. The storage 105 can include a plurality of other components in addition to the operating system software 21. This secure boot chain which utilizes a chain of trust helps to ensure that the lowest levels of software are not tampered with and allows the operating system to run only on validated devices from the vendor. In one embodiment, the vendor can be a company that has provided and develops the operating system 21 and the platform apps 33. In one embodiment the platform apps 33 can include a standard set of software which is provided with a software build for a device such that each device from the vendor comes with the operating system and the platform apps (and bundled software daemons). In one embodiment, the platform apps can include standard software applications such as a web browser (e.g., Mobile Safari), email application, and other standard software components that are bundled with the operating system for distribution on devices, such as a smartphone or tablet computer or other data processing systems.

The non-volatile storage 105 can include a plurality of different software components including the operating system software component 21 which can include boot code as well as kernel software used to create an operating environment as is known in the art. Further, storage 105 can also include launch software 25 which can be software which performs the function of launching other software components, either on demand when a user launches a user application, such as a platform application or a third party application, or based on a list of daemons in a list, such as a property list stored in property lists 23. In one embodiment, the launch software 25 can be a user process which runs in user memory space while the operating system or the kernel of the operating system runs in kernel memory space. In one embodiment, the launch software 25 can be responsible for launching, either directly or indirectly, all other software components, including software applications and software daemons. In one embodiment, the launch software can be the software component known as launched used in the OS X operating system from Apple Inc. of Cupertino, Calif. and also used in the iOS operating system from Apple Inc. of Cupertino, Calif. In one embodiment, the launch software 25 can be the first user process which is launched by the kernel after the kernel completes its boot up process. In one embodiment, the launch software, after it is launched, can launch the application 29 which can be a user interface application such as Springboard or the Finder which is used by a user to launch user applications (which can be either platform applications or third party applications).

In one embodiment, the non-volatile storage 105 also includes code verification software 27 which is utilized to verify the authenticity of the software image either before or after it is launched. In one embodiment, the code verification software can include one or more software components which can provide different code verification processes depending upon the code which is being verified. In one embodiment, the code verification software can have at least two paths for verifying software. One path can utilize a trust cache of hashes 31 which contains, as is known in the art, hashes of known and authentic software bundled with a software build (which includes a version of the operating system and a corresponding version of the platform apps 33 and daemons bundled with the operating system). The use of the trust cache can be one path for code verification while the evaluation or verification of signed code using a certificate from a trusted authority or source can be another path for a code verification process. In one embodiment, two different software processes can be invoked depending upon the path. For example, in the case of the Apple iOS operating system, the AppleMobileFileIntegrity kernel extension can be used to verify apps and daemons in the platform apps 33 which come bundled with the operating system as part of a standard software build. In other words, the AppleMobileFileIntegrity (AMFI) can be the code verification software process which verifies or authenticates platform apps and platform daemons which are bundled with a software build which includes the operating system and the platform apps and platform daemons from the vendor of the operating system. Another software component known as the AMFI daemon (amfid) performs verification for software which originates from parties other than the vendor of the operating system and platform apps (and platform daemons), in which case third party apps are verified by verifying the code signature for the third party app, such as third party apps 35. Such third party apps can include apps such as Angry Birds, Facebook, Yelp, etc. As is known in the art, as the operating system completes its boot up process and as software applications begin to be launched, the executing code for these various software components are stored in the volatile storage 107.

In one embodiment, the trust cache 31 is a signed file with all of the hashes of the binaries of all platform apps and platform daemons that are bundled with the build of the operating system from the vendor of the operating system or the vendor of the device which includes the operating system and the bundled platform apps and platform daemons. The trust cache includes, in one embodiment, hashes for launchd, cloudd, Springboard, MobileSafari and other platform apps and other daemons that are bundled with the build of the iOS operating system from the vendor Apple Inc. of Cupertino, Calif. which also provides a device, such as an iPhone or iPad table to run the build of the operating system and other bundled components such as the platform apps and the daemons that are bundled with the build of the operating system. The trust cache, as described herein, is used during a code verification process to verify the authenticity of the software provided by the vendor of the build of the operating system and the rest of the bundled components. In one embodiment, the trust cache does not include hashes of any third party code such as software from companies other than the vendor of the operating system or the device which created the build of the operating system which is bundled with the platform apps and daemons. In this instance, the trust cache can only be used to verify the authenticity of software from the vendor which created the build of the operating system or the vendor of the device which bundled the operating system with the platform apps and other daemons.

The third party apps 35 can be a collection of one or more third party applications that can be signed by a certificate from a trusted authority such as a vendor of the operating system 21 or a vendor of the app store which provided the third party app to the device that contains the storage 105. The third party is, in one embodiment, different than the vendor of OS 21 or the vendor of the app store. There are numerous ways in which an app can be signed with a certificate in order to ensure its authenticity. For example, a developer (a third party) who is preparing the software for the third party app can obtain a certificate from a vendor of the operating system or device or app store or some other trusted authority. In one embodiment, the certificate can be obtained from an entity which creates the operating system 21 and the platform apps 33 and which also provides an app store from which the app can be distributed to end users. The certificate can include an identifier of the developer and/or the developer's public key and can be encrypted by the vendor's private key. The certificate can be bundled or concatenated with the binary of the compiled code written by the developer or otherwise created by the developer. The developer can then sign the code with the certificate and then provide the signed code to the app store for distribution to end users. After the end user downloads the app, it can be evaluated at run time using techniques which are known in the art such as those done by third party apps obtained from Apple's app store.

The embodiments described herein can be implemented in a system with the software architecture shown in FIG. 1. However, in other embodiments, a system can implement code verification without some of the elements shown in FIG. 1, such as the secure boot ROM 103. In other embodiments, the system may have additional elements or features to enhance security, such as a fingerprint sensor to authenticate a user, etc.

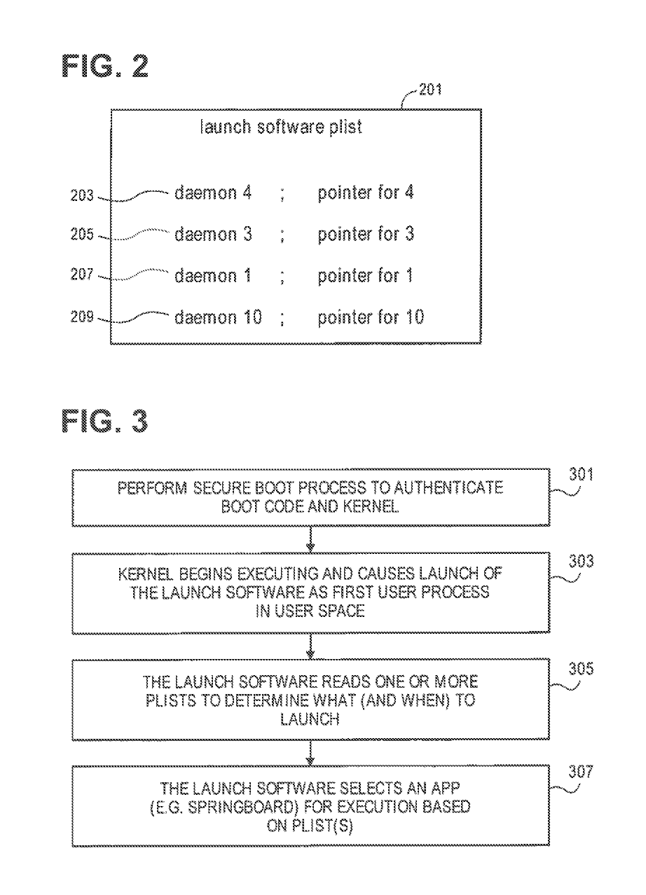

FIG. 2 shows an example of a property list 201 for a launch software, such as the launch software 25 shown in FIG. 1. The property list 201 includes a plurality of entries, such as entries 203, 205, 207, and 209 each of which is for a particular daemon in a set of daemons (e.g. platform daemons) scheduled or otherwise set to be launched by the launch software, such as launch software 25. It will be appreciated that the property list 201 for launch software 25 can include other information not shown in FIG. 2 such as the conventional information known in the art for a property list, configuration file or other type of data file for launch software, such as the launch software “launchd” from Apple Inc. of Cupertino, Calif. The property list 201 can include a list of daemons to launch according to a schedule or sequence specified in the list. The launch software, in one embodiment, uses the property list to determine what and when to launch. Some launches are scheduled and other launches can be on user or system demand (for example, system demand can be when one app or daemon already launched causes the launching through the launch software 25 of a daemon on demand from the app or daemon that was already launched). The pointers, such as “pointer for 4” in entry 203, specify, in one embodiment, where the software to be launched is stored to allow the launch software to cause the software to be launched, typically through the kernel of the operating system, such as operating system 21. In one embodiment, the pointer can be a path name in a file system directory which specifies the logical location (on persistent storage such as flash memory) of the software to be launched. In one embodiment, the launch software 25 uses the source of the launch job or request to determine the expected path of the software verification process, for example, if the source is from the property list 201 (stored on persistent storage) then the trust cache path is the expected path for software verification. In an alternative embodiment, the path name in property list 201 can also indicate to the launch software 25 (in the alternative embodiment) the expected path of the code verification process. For example, in this alternative embodiment if the path name is for a platform app or a daemon bundled with the operating system build (and therefore a hash of the platform app or bundled daemon is in the trust cache 31), then the code verification path is the path that uses the trust cache 31 rather than evaluating the signature of the signed code from a third party app. On the other hand if the path name is for a third party app that was, for example, installed by the user from an app store, then the path name will determine that the code signature path is expected to be used by the code verification software. Path names for platform apps or bundled daemons will have in one embodiment, known, predetermined names that can be relied upon to determine that the code verification path is expected to use the trust cache. For example, “pointer for 4” for entry 203 shown in property list 201 can be a path name for a daemon or platform application such as the Springboard software application which presents icons of different applications in a graphical user interface which allows a user to launch an application by touching the icon displayed on a touchscreen display and input device.

The property list 21 can specify a sequence or order for launching various daemons. For example in the case of FIG. 2, daemon in entry 203 (daemon 4) is launched before daemon 3 and before daemon 1 and before daemon 10. Similarly, daemon 3 is launched before daemon 1 and daemon 10. In addition, in one embodiment, the property list 201 can specify conditions which need to be satisfied before a daemon is launched by launch software 25.

Various methods will now be described which can utilize the software architecture shown in FIG. 1 and the property list shown in FIG. 2 to verify that the proper code verification path was taken at launch time for software that is launched on a device, such as the device having the software architecture shown in FIG. 1.

FIG. 3 shows a method which can be used in one embodiment for powering up a device from an off state. In operation 301, a secure boot process can be performed to authenticate the boot code and kernel of the operating system as the device boots up or starts up. Operation 301 can be a conventional process known in the art which utilizes a secure boot ROM, such as the secure boot ROM 103 described above. In one embodiment, the secure boot ROM can employ a chain of trust as described above to securely boot the system and launch the kernel of the operating system. In operation 303, the kernel begins executing and causes the launch of the launch software 25 which in one embodiment can be the first user process which is launched in user memory space. Next, in operation 305, the launch software, such as launch software 25, can read one or more property lists to determine what and when to launch. In one embodiment, the property list for the launch software 25 can be similar to the property list 201 shown in FIG. 2. Then in operation 307, the launch software 25 can select an app or daemon for execution based on the information in one or more property lists, such as the property list 201 for the launch software. In one embodiment, a platform app or a plurality of platform apps can be scheduled for launching in the property list along with one or more daemons. For example a platform app such as the Springboard application for the iOS operating system (from Apple Inc. of Cupertino, Calif.) can be among the first set of applications and daemons which are launched. In one embodiment, the launch software 25 may launch the Springboard application before launching any other platform apps and before launching any other daemons that are bundled with the operating system, such as operating system 21. The Springboard application is an example of a user application that displays, or otherwise presents, a user interface which shows icons (or other user selectable items) that allow a user to select an application to cause the application to be launched or run in response to the user's selection. Such user application can, in one embodiment, display icons (or other user selectable items) of both platform applications and third party applications, either of which can be selected by the user; in one embodiment, such user application can specify to the launch software (e.g. launch software 25) whether the user's selection is a platform application or a third party application, and this specification (of either a platform or third party application) can be used to determine the expected code verification path.

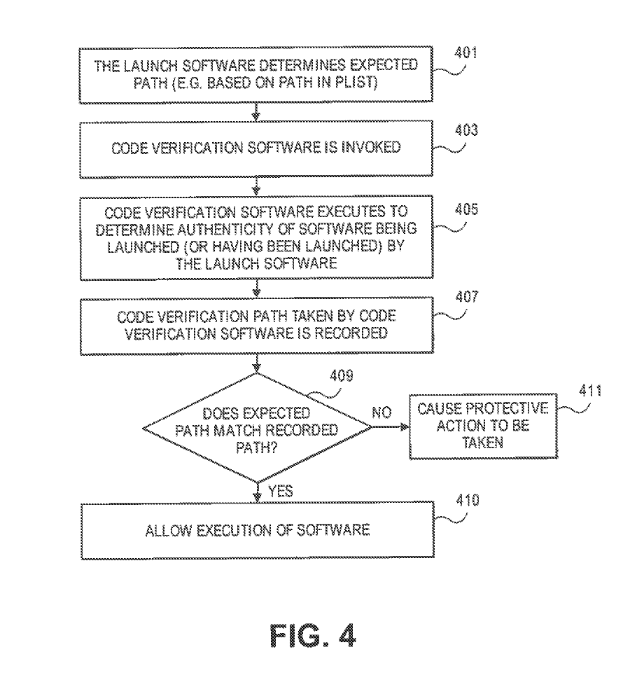

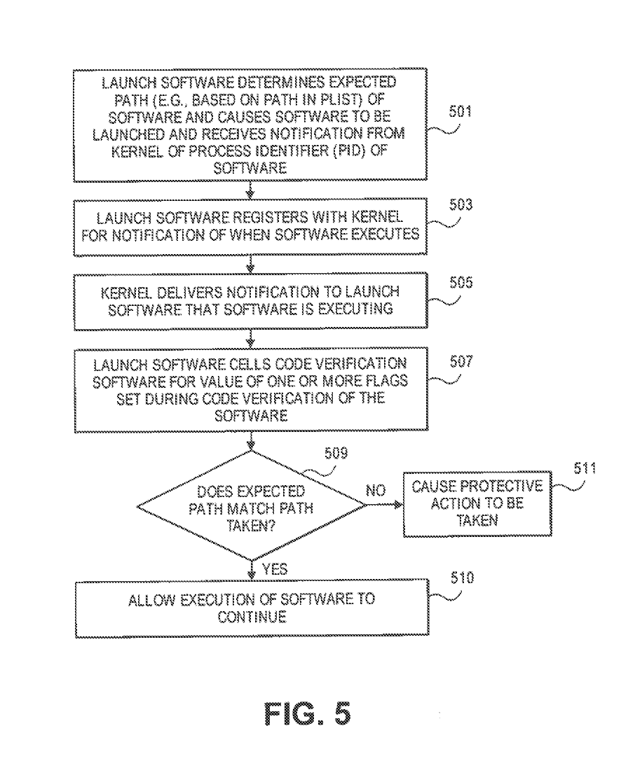

Once the launch software 25 has selected an app for launching (or been requested to launch an application), the method shown in FIG. 4 can be employed to audit the code verification path; in an alternative embodiment, the method shown in FIG. 5 can be employed to audit a code verification path taken by the code verification software. Referring to FIG. 4, the launch software 25 (or other software component) determines, in operation 401, the expected path for the code verification process. This expected path can be determined in various ways, such as a technique that uses the source or request for the launch software's launch job. For example, in one embodiment, the launch software 25 (or another software component) can determine the expected path based upon the source of the request or job to launch the selected application. The source, in one embodiment, can be either (1) a property list (or similar data structure) used by the launch software 25 to launch platform daemons or (2) a user application, such as Springboard or Finder or similar applications, that present a user interface which shows icons or other user selectable items that allow a user to select an application to be launched or run. In this embodiment, if the source is a property list (such as a property list that specifies platform daemons and their storage locations in a file system on a persistent storage), then the expected path is the software verification process that uses the trust cache because the platform daemons are bundled with the operating system and their hashes are included in the trust cache. If the source is the user application that is used by a user to select an application (to cause it to be launched or to run) then the expected path is the software verification process that evaluates the signature of signed code) unless the user application indicates that the user's selected application is a platform application in which case the expected path is the software verification path that uses the trust cache. Thus, the user application (e.g. Springboard) specifies (e.g. through an interprocess communication call) to the launch software whether the selected application (selected by the user) is a platform application or a third party application. If the user application indicates the user's selected application is a platform application then the trust cache is used, and if the user application indicates the user's selected application is a third party application then the software verification process uses the evaluation of the signature of signed code. In an alternative embodiment, the expected path can be used upon the path name in a property list used by the launch software. The launch software referred to in operation 401 can be a daemon software which is the first user process launched in user space after a set of one or more kernel software components load and establish a kernel memory space during a secure boot up procedure which verifies code signatures in a chain of trust starting from a boot ROM as described above. In operation 403, the code verification software is invoked. In one embodiment, the code verification software may include multiple components which perform the different paths of code verification as described above. For example, AMFI can verify software using a trust cache, such as the trust cache 31 while amfid can verify signed code for third party apps, such as third party apps 35. The code verification software can be invoked by the launch software, such as launch software 25 or can be invoked by another software component such as a component of the kernel of an operating system, such as operating system 21. In operation 405 the invoked code verification software executes to determine the authenticity of software being launched (or having been launched) by the launch software. In operation 407, the code verification path taken by the code verification software is recorded. In one embodiment, the recording of the path taken can be done by setting a flag which indicates that the trust cache 31 was used to verify the code or that the signature of a third party app, such as third party app 35 was authenticated or verified. Then operation 409 can be performed to determine whether the expected path matches the recorded path. In particular, operation 409 determines whether the expected path which was determined in operation 401 matches the recorded path which was recorded in operation 407. Operation 409 can be done by the launch software, such as launch software 25 in one embodiment or in an alternative embodiment can be performed by the kernel of an operating system, such as the operating system 21 or by another trusted software component that is trusted by operating system 21. If the expected path does match the recorded path then the software is allowed to execute in operation 410. On the other hand, if the expected path does not match the recorded path, then the system can take protective action in operation 411. The system may need to take protective action because the mismatch discovered in operation 409 indicates that a hacker may have introduced malicious code into the system. In one embodiment, the protective action can involve any one of a set of possible operations including: rebooting the data processing system to a restore mode which requires reinstallation of software; rebooting the data processing system to recovery mode: causing a kernel panic; or disabling the software component which attempted to fool the system by taking a path that is different than the expected code verification path. The method shown in FIG. 4 can perform the comparison in operation 409 before the software component begins execution in one embodiment; in another embodiment, such as the embodiment shown in FIG. 5, the comparison of the expected path to the path taken is done after the software component begins executing.

FIG. 5 shows a method according to one embodiment for auditing the code verification process. In operation 501, the launch software, such as launch software 25 can determine an expected path of the code verification process for software that is about to be launched. The expected path can be determined based upon any one of a variety of different ways including the source of the launch job or request or in an alternative embodiment a path name in a property list, such as the property list 201. The launch software causes the software to be launched and receives a notification from the kernel, such as a kernel of the operating system 21, of a process identifier (PID) of the software. Then in operation 503, the launched software registers with the kernel for notification from the kernel when the software launched in operation 501 begins to execute. In operation 505 the kernel can deliver notification to the launch software once the software begins executing. In one embodiment, the software may not execute immediately after being launched. In response to the notification in operation 505, the launch software in operation 507 calls one or more code verification software components for a value of one or more flags which were set during the code verification of the software launched in operation 501. The flags will specify the actual path taken in the code verification process and can be used in operation 509 in which the path taken is compared to the expected path which was determined in operation 501. If the expected path matches the path taken then the software is allowed to continue execution in operation 510. On the other hand, if the expected path does not match the path taken then the system can take protective action in operation 511, which can be similar to the protective actions described above in connection with operation 411. While the method shown in FIG. 5 audits the path taken after the software has begun executing, in an alternative embodiment, a method can rely upon the kernel to perform the comparison operation before execution begins; this can be implemented by having the launch software communicate the expected path to the kernel at the time when the launch software instructs the kernel to launch the software. For example, the launch software can inform the kernel that it expects the path to be from the trust cache and the kernel can then take protective action if the code verification process does not use the trust cache before starting to execute the software which may be an untrusted process.

In one embodiment, the launch software, such as launch software 25 may perform operations in conjunction with interprocess communication (IPC). For example, the launch software may be involved in interprocess communications between the launch software itself and other processes such as other daemons or applications, etc. In one embodiment, the launch software can be configured to deny an interprocess communication if the caller (which requests the interprocess communication with the launch software) is not software which has a hash in the trust cache, such as the trust cache 31. In other words, if the caller software does not have a hash of its binary in the trust cache, then the launch software denies the IPC request or action. This can prevent the use of interprocess communication with the launch software when the software which calls for the interprocess communication was not bundled with the operating system and platform apps and daemons that came with the build of the operating system. In other words, a third party application in this embodiment will not be able to access the launch software's functionality through an IPC.

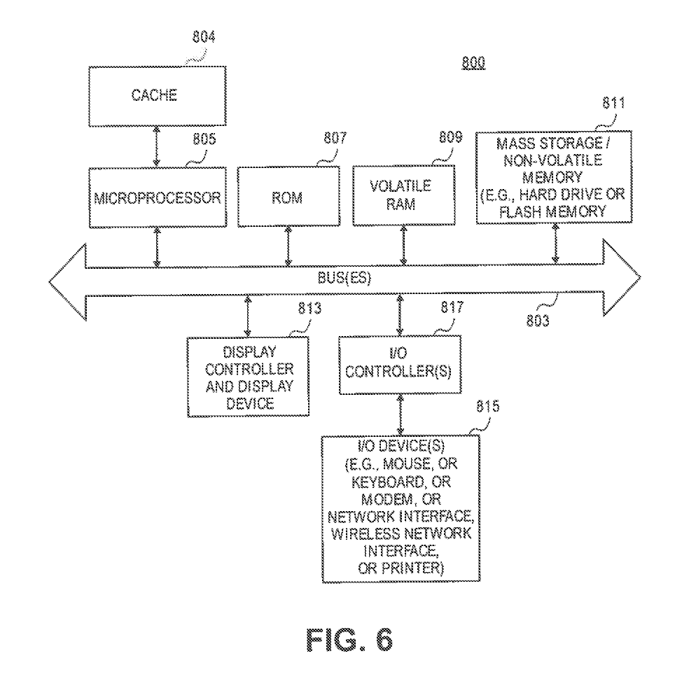

FIG. 6 shows one example of a data processing system, which may be used with any one of the embodiments described herein. Note that while FIG. 6 illustrates various components of a data processing system, it is not intended to represent any particular architecture or manner of interconnecting the components as such details are not germane to this description. It will also be appreciated that network computers, tablet computers, smartphones, consumer electronic devices and other data processing systems which have fewer components or perhaps more components may also be used with one or more embodiments described herein.

As shown in FIG. 6, the computer system 800, which is a form of a data processing system, includes a bus 803 which is coupled to one or more microprocessor(s) 805 and a ROM (Read Only Memory) 807 and volatile RAM 809 (e.g. DRAM) and a non-volatile memory 811. The one or more microprocessors 805 are coupled to optional cache 804. The one or more microprocessors 805 may retrieve the stored instructions from one or more of the non-transitory memories 807, 809 and 811 and execute the instructions to perform operations described above. These memories represent examples of machine readable non-transitory storage media that can store or contain computer program instructions which when executed cause a data processing system to perform the one or more methods described herein. The bus 803 interconnects these various components together and also interconnects these components 805, 807, 809 and 811 to a display controller and display device 813 and to peripheral devices such as input/output (I/O) devices 815 which may be one or more of mice, touch screens, touch pads, touch sensitive input devices, keyboards, modems, network interlaces, printers and other devices which are well known in the art. Typically, the input/output devices 815 are coupled to the system through input/output controllers 817. The volatile RAM (Random Access Memory) 809 is typically implemented as dynamic RAM (DRAM) which requires power continually in order to refresh or maintain the data in the memory.

The mass storage 811 is typically a magnetic hard drive or a magnetic optical drive or an optical drive or a DVD RAM or a flash memory or other types of memory system which maintain data (e.g., large amounts of data) even after power is removed from the system. Typically the mass storage 811 will also be a random access memory although this is not required. While FIG. 6 shows that the mass storage 811 is a local device coupled directly to the rest of the components in the data processing system, it will be appreciated that one or more embodiments may utilize a non-volatile memory which is remote from the system, such as a network storage device which is coupled to the data processing system through a network interface such as a modem, an Ethernet interface or a wireless network. The bus 803 may include one or more buses connected to each other through various bridges, controllers and/or adapters as is well known in the art.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A non-transitory machine readable medium storing executable program instructions which when executed by a data processing system cause the data processing system to perform a method comprising:
determining an expected path of a code verification process for a first software component, wherein the code verification process has at least two paths which are different and wherein the first software component is a software application or a software daemon;
causing the code verification process to perform a code verification on the first software component to determine whether the first software component is authentic;
comparing the expected path to the path taken by the code verification process when the code verification on the first software component was performed;
causing a protective action to occur in response to determining from the comparison that the path taken does not match the expected path.

2. The medium as in claim 1, wherein the code verification process records the path taken and wherein the at least two paths comprise: a first path for checking a trust cache of hashes of binaries from a build of an operating system and platform applications and a second path for evaluating a signature of a signed code for a software component.

3. The medium as in claim 2 wherein the expected path is determined by one of: a first daemon which launches software components including software applications and software daemons or a trusted software component.

4. The medium as in claim 3 wherein the first daemon is the first user process launched in user space after a set of one or more kernel software components establish a kernel space during a secure boot up procedure which verifies code signatures in a chain of trust starting from a boot ROM.

5. The medium as in claim 4 wherein the first daemon determines the expected path from a source of the request to launch the first software component, wherein the source is either a property list that specifics a storage location for the first software component or a user application that presents a graphical user interface which shows icons to allow a user to select an icon to launch the application represented by that icon.

6. The medium as in claim 5 wherein if the source is the property list then the expected path is the first path and if the source is a third party application displayed in the user application then the expected path is the second path.

7. The medium as in claim 6 wherein the user application indicates whether the first software component is a platform application or a third party application.

8. The medium as in claim 6 wherein the protective action is one of: rebooting the data processing system to a restore mode requiring a re-installation of software; rebooting the data processing system to a recovery mode; causing a kernel panic; or disabling the first software component.

9. The medium as in claim 3 wherein an interprocess communication from a calling software to the first daemon is denied if the calling software does not include a hash in the trust cache.

10. The medium as in claim 3 wherein the comparison of the expected path to the path taken is done after the first software component begins executing, and wherein the second path is used for software applications and software daemons that are not part of the build and wherein the trust cache is static for the build and is contained in a signed file and wherein an update to any part of the operating system or a platform application requires a new trust cache for a new build which remains static for the new build.

11. A machine implemented method comprising:
determining an expected path of a code verification process for a first software component, wherein the code verification process has at least two paths which are different and wherein the first software component is a software application or a software daemon;
causing the code verification process to perform a code verification on the first software component to determine whether the first software component is authentic;
comparing the expected path to the path taken by the code verification process when the code verification on the first software component was performed;
causing a protective action to occur in response to determining from the comparison that the path taken does not match the expected path.

12. The method as in claim 11, wherein the code verification process records the path taken and wherein the at least two paths comprise: a first path for checking a trust cache of hashes of binaries from a build of an operating system and platform applications and a second path for evaluating a signature of a signed code for a software component.

13. The method as in claim 12 wherein the expected path is determined by one of: a first daemon which launches software components including software applications and software daemons or a trusted software component.

14. The method as in claim 13 wherein the first daemon is the first user process launched in user space after a set of one or more kernel software components establish a kernel space during a secure boot up procedure which verifies code signatures in a chain of trust starting from a boot ROM.

15. The method as in claim 14 wherein the first daemon determines the expected path from a source of the request to launch the first software component, wherein the source is either a property list that specifies a storage location for the first software component or a user application that presents a graphical user interface which shows icons to allow a user to select an icon to launch the application represented by that icon.

16. The method as in claim 15 wherein if the source is the property list then the expected path is the first path and if the source is a third party application displayed in the user application then the expected path is the second path.

17. The method as in claim 16 wherein the user application indicates whether the first software component is a platform application or a third party application.

18. The method as in claim 16 wherein the protective action is one of: rebooting the data processing system to a restore mode requiring a re-installation of software; rebooting the data processing system to a recovery mode; causing a kernel panic; or disabling the first software component.

19. The method as in claim 13 wherein an interprocess communication from a calling software to the first daemon is denied if the calling software does not include a hash in the trust cache.

20. The method as in claim 13 wherein the comparison of the expected path to the path taken is done after the first software component begins executing, and wherein the second path is used for software applications and software daemons that are not part of the build and wherein the trust cache is static for the build and is contained in a signed file and wherein an update to any part of the operating system or a platform application requires a new trust cache for a new build which remains static for the new build.
